(19) United States
(12) Patent Application Publication
(10) Pub. No.: US 2025/0021217 A1
(43) Pub. Date: Jan. 16, 2025

(54) CONTROL APPARATUS, METHOD, AND STORAGE MEDIUM

(71) Applicant: CANON KABUSHIKI KAISHA, Tokyo (JP)

(72) Inventor: Shohei IWAMOTO, Kanagawa (JP)

(21) Appl. No.: 18/768,062

(22) Filed: Jul. 10, 2024

(30) Foreign Application Priority Data
Jul. 14, 2023 (JP) 2023-115928

(51) Int. Cl. G06F 3/04842; G06Q 30/0241

(52) U.S. Cl. CPC G06F 3/04842; G06Q 30/0241

(57) ABSTRACT

An object of the present disclosure is to make it easy to designate a virtual object(s) suitable for the current virtual camera position. A control apparatus according to the present disclosure obtains a virtual camera parameter including information of at least one of a position, an orientation, or an angle of view of a virtual camera in a virtual space. Based on the virtual camera parameter, the control apparatus generates a user interface that assists a user to make an input for selecting one or more virtual object groups from among a plurality of virtual object groups to each of which one or more virtual objects belong. Moreover, based on the input for selecting the virtual object groups from the user, the control apparatus determines the virtual object groups.

### BACKGROUND

### Field

The present disclosure relates to a user interface (UI) technology for generating a virtual viewpoint image.

### Description of the Related Art

There is a technology for generating a virtual viewpoint image whose viewpoint is freely changeable by generating three-dimensional shape data with data of multiple captured images obtained by synchronized image capturing by multiple image capturing apparatuses installed at different positions. This technology involves capturing an image of the generated three-dimensional shape data with a virtually created camera (hereinafter “referred to as virtual camera”) to generate an image of the three-dimensional shape data as seen from any virtually created viewpoint (hereinafter “virtual viewpoint”) as a virtual viewpoint image. In such a virtual viewpoint image, virtually created advertisements (hereinafter referred to as “virtual advertisements”) or the like as virtual objects can be displayed. Japanese Patent Laid-Open No. 2022-090786 discloses a technology for displaying virtual advertisements in a virtual viewpoint image based on designation by a user who operates display of virtual advertisements in the virtual viewpoint image (hereinafter referred to as “operator”).

The virtual objects to be displayed in the virtual viewpoint image may vary in the position, orientation, size, and so on in a virtual space. For this reason, whether the virtual objects, such as virtual advertisements, can be effectively displayed or not varies depending on at least one of the position of the virtual camera (hereinafter referred to as “virtual camera position”), its orientation, or its direction. The operator is therefore required to designate suitable virtual objects and place them in the virtual space based on the current virtual camera position and the like. However, it is difficult to instantaneously determine and designate suitable virtual objects while operating the virtual camera, e.g., moving the virtual camera position. The present disclosure has been made in view of the above problem, and an object thereof is to provide a technology that makes it possible for an operator to easily designate a virtual object(s) suitable for the current virtual camera position or the like.

### SUMMARY

A control apparatus according to the present disclosure includes: one or more hardware processors; and one or more memories storing one or more programs configured to be executed by the one or more hardware processors, the one or more programs including instructions for: obtaining a virtual camera parameter including information of at least one of a position, an orientation, or an angle of view of a virtual camera in a virtual space; based on the virtual camera parameter, generating a user interface that assists a user to make an input for selecting one or more virtual object groups from among a plurality of virtual object groups to each of which one or more virtual objects belong; and based on the input for selecting the virtual object groups from the user, determining the virtual object groups.

Further features of various embodiments will become apparent from the following description of exemplary embodiments with reference to the attached drawings.

### BRIEF DESCRIPTION OF THE DRAWINGS

FIG. 1 is a block diagram illustrating an example of the configuration of a control system according to Embodiment 1;

FIG. 2 is a block diagram illustrating an example of the hardware configuration of apparatuses included in the control system according to Embodiment 1;

FIG. 3 is a flowchart illustrating an example of the flow of a process by a virtual camera control apparatus according to Embodiment 1;

FIG. 4 is a flowchart illustrating an example of the flow of a process of determining a virtual advertisement group identifier (ID) by the virtual camera control apparatus according to Embodiment 1;

FIG. 5 is a flowchart illustrating an example of the flow of a process of determining recommended ranges by the virtual camera control apparatus according to Embodiment 1;

FIG. 6 is a diagram illustrating an example of a UI for designating recommended ranges generated by a UI generation unit according to Embodiment 1;

FIG. 7 represents an example of a UI for designating a virtual advertisement group generated by the UI generation unit according to Embodiment 1;

FIGS. 8A and 8B are flowcharts illustrating an example of the flows of processes by an image generation apparatus according to Embodiment 1;

FIG. 9 is a block diagram illustrating an example of the configuration of a control system according to Embodiment 2; and

FIG. 10 is a flowchart illustrating an example of the flow of a process by a virtual camera control apparatus according to Embodiment 2.

### DESCRIPTION OF THE EMBODIMENTS

Hereinafter, with reference to the attached drawings, the present disclosure explains some example embodiments in detail. Configurations shown in the following embodiments are merely exemplary and some embodiments of the present disclosure are not limited to the configurations shown schematically. Note that identical components will be described with the same reference sign given thereto.

### Embodiment 1

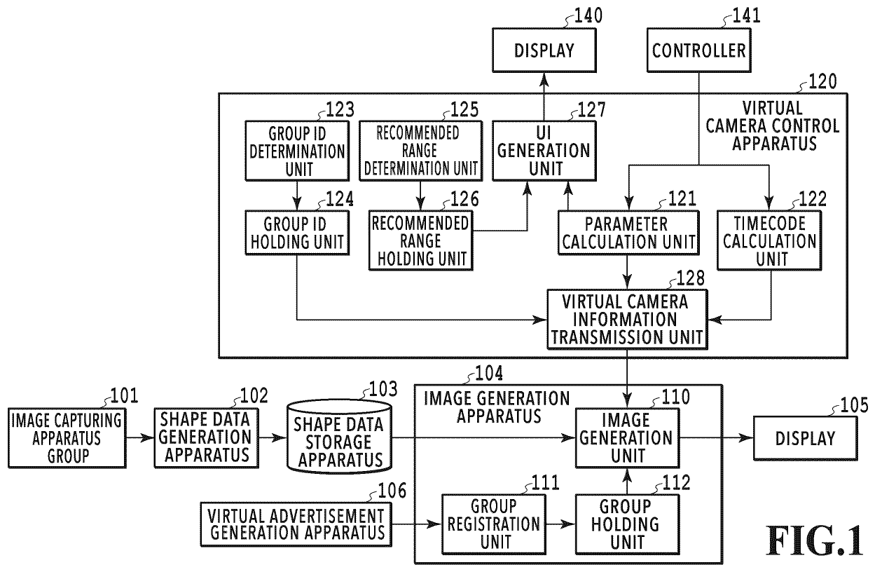

FIG. 1 is a block diagram illustrating an example of the configuration of a control system according to Embodiment 1. FIG. 1 also illustrates functional components of a virtual camera control apparatus 120 and an image generation apparatus 104. An image capturing apparatus group 101 includes multiple image capturing apparatus, and each image capturing apparatus is placed at a different position from the others. Each image capturing apparatus is configured to capture an image of at least part of an image capturing target space, and performs the image capturing in synchronization with the others. Data of the multiple captured images obtained by the synchronized image capturing by the image capturing apparatuses (hereinafter referred to as “multi-viewpoint image data”) is transmitted to a shape data generation apparatus 102.

The shape data generation apparatus 102 receives the multi-viewpoint image data transmitted from the image capturing apparatus group 101, extracts an image region covering an object for which to generate three-dimensional shape data as a foreground from each captured image, and generates a silhouette image indicating the foreground's silhouette. Also, the shape data generation apparatus 102 generates three-dimensional shape data representing the foreground's three-dimensional shape by using Visual Hull based on the generated silhouette image. Incidentally, the method of extracting a foreground from each captured image, and the method of generating the three-dimensional shape data by Visual Hull are well known, and description thereof is omitted. The three-dimensional shape data generated by the shape data generation apparatus 102 is transmitted to a shape data storage apparatus 103. The shape data storage apparatus 103 has a large-capacity storage device, such as a hard disk drive (HDD), and receives the three-dimensional shape data transmitted from the shape data generation apparatus 102 and stores it in the storage device.

The virtual camera control apparatus 120 is an apparatus for the operator to operate a virtual camera for generating a virtual viewpoint image. The virtual camera control apparatus 120 has a parameter calculation unit 121, a timecode calculation unit 122, a group ID determination unit 123, a group ID holding unit 124, and a recommended range determination unit 125 as functional components. The virtual camera control apparatus 120 also has a recommended range holding unit 126, a UI generation unit 127, and a virtual camera information transmission unit 128 in addition to the above functional components.

The parameter calculation unit 121 receives operation information output from a controller 141 in response to the operator's operation on the controller 141, and calculates virtual camera parameters including information on the virtual camera's position, orientation, and angle of view based on the operation information. The virtual camera parameters calculated by the parameter calculation unit 121 are transmitted to the UI generation unit 127 and the virtual camera information transmission unit 128. In one example, in a case of expressing the virtual camera position with three-dimensional coordinates [X, Y, Z] in a virtual space, the parameter calculation unit 121 calculates numerical values like X=4.0, Y=9.0, and Z=1.5 as the virtual camera position. It is to be noted that, in the present embodiment, the unit for each coordinate is the meter [m], and the position of the origin is the center of a range in the virtual space in which to generate the three-dimensional shape data. Moreover, in a case where the X axis is designated to be parallel to the ground surface, the Y axis is designated to be parallel to the ground surface and perpendicular to the X axis, and the Z axis is designated to be perpendicular to the ground surface.

Also, in a case of expressing the orientation of the virtual camera with three angles [Pan, Tilt, Roll], the parameter calculation unit 121 calculates numerical values like Pan=20.0, Tilt=10.0, and Roll=2.0 as the orientation of the virtual camera. In the present embodiment, the unit for the angles is degrees [°], and the value ranges of Pan, Tilt, and Roll are from −180 to 180. Note that Pan is the angle of rotation in a direction parallel to the ground surface, Tilt is the angle of rotation in a direction perpendicular to the ground surface, and Roll is the angle of rotation about the optical axis of the virtual camera as a rotation axis. Also, in a case of expressing the angle of view of the virtual camera with a focal length [Zoom], the parameter calculation unit 121 calculates a numerical value like Zoom=6.0 as the angle of view of the virtual camera. In the present embodiment, the unit for the focal length is the millimeter [mm]. The controller 141 includes a joystick and the like. In the present embodiment, the operator operates the joystick of the controller 141 to operate the virtual camera. For example, the virtual camera position changes according to the amount of tilt of the joystick and its direction.

The timecode calculation unit 122 receives the operation information output from the controller 141 in response to the operator's operation on the controller 141, and calculates a timecode for the virtual viewpoint image based on the operation information. The calculated timecode is transmitted to the virtual camera information transmission unit 128. The controller 141 includes a jog dial and the like. In the present embodiment, in one example, the operator operates the jog dial of the controller 141 to input an instruction to, for example, play, pause, rewind, or fast-forward the virtual viewpoint image and determine a timecode.

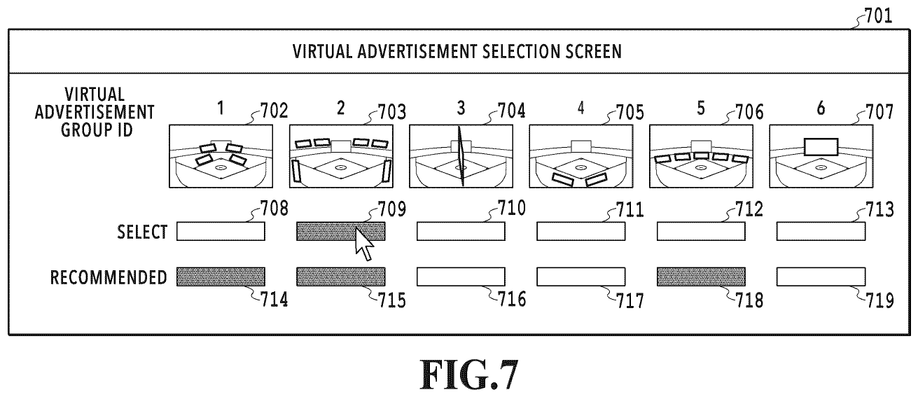

The group ID determination unit 123 determines a virtual advertisement group ID based on the operator's designation. The virtual advertisement group ID is an identifier for uniquely identifying a virtual advertisement group for collectively handling one or more virtual advertisements. Incidentally, in the present embodiment, examples of the method for the operator to designate a virtual advertisement group ID include the following method. For example, using a mouse or the like, the operator presses one of buttons 708 to 713 in a UI 701 exemplarily illustrated in FIG. 7 to be mentioned later which is displayed on a display 140 to designate a virtual advertisement group. The example of the UI 701 illustrated in FIG. 7 represents a state where the operator has pressed the button 709, so that the virtual advertisement group corresponding to the button 709 has been designated, and 2 has been determined as the virtual advertisement group ID as a result of this designation. The virtual advertisement group ID determined by the group ID determination unit 123 is transmitted to the group ID holding unit 124.

The group ID holding unit 124 receives the virtual advertisement group ID transmitted from the group ID determination unit 123, and stores and holds it in a storage device, such as an HDD or a random-access memory (RAM). In the following description, the group ID holding unit 124 holds 2 in a case where 2 has been determined as the virtual advertisement group ID, as in the UI 701 illustrated in FIG. 7, for example.

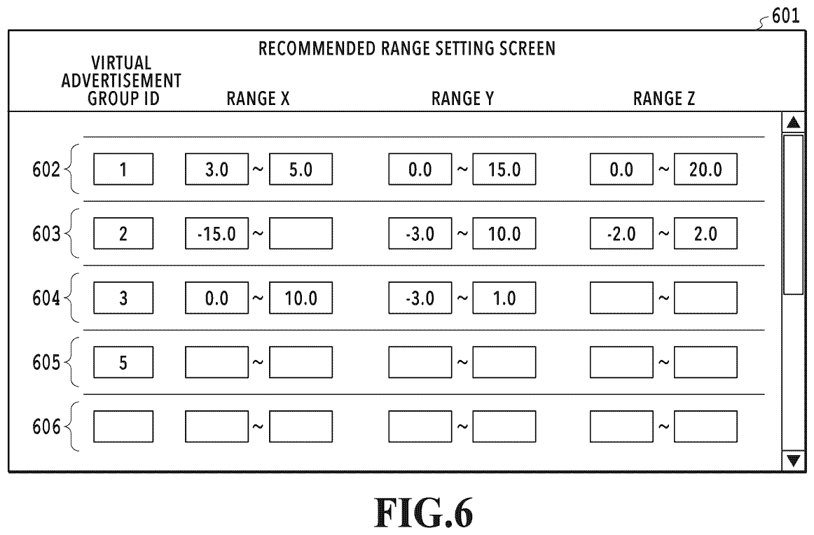

The recommended range determination unit 125 determines recommended ranges for virtual advertisement groups based on the operator's designation. A recommended range represents a range for the virtual camera position determined individually for a virtual advertisement group. In a case where the virtual camera position is within the range of a recommended range, the virtual advertisement group corresponding to this recommended range is recommended to the operator. Information of the recommended range determined by the recommended range determination unit 125 is transmitted to the recommended range holding unit 126. Incidentally, in the present embodiment, examples of the method for the operator to designate a recommended range include the following method. For example, using a mouse and a keyboard or the like, the operator inputs numerical values into any of text box groups 602 to 606 in a UI 601 exemplarily illustrated in FIG. 6, which will be described later, displayed on the display 140. Based on this input, the recommended range corresponding to the virtual advertisement group is designated.

The example of the UI 601 illustrated in FIG. 6 represents a state where 1 is designated as the virtual advertisement group ID for the text box group 602. The example also represents a state where 3.0 to 5.0 in the X-axis direction, 0.0 to 15.0 in the Y-axis direction, and 0.0 to 20.0 in the Z-axis direction are designated as a recommended range for the virtual advertisement group with the virtual advertisement group ID 1. In this case, a cuboidal space measuring 2.0 m in the X-axis direction, 15.0 m in the Y-axis direction, and 20.0 m in the Z-axis direction is set as the recommended range at a designated position. Note that the method for the operator to designate a recommended range is not limited to the designation method in which the operator inputs numerical values into text boxes, as with the UI 601 illustrated in FIG. 6. For example, the operator may graphically designate a recommended range by deforming a three-dimensional object, such as a cuboidal object, in a three-dimensional space displayed as a UI by using a mouse or the like. Note that the present embodiment will be described on the assumption that the shape of recommended ranges is cuboidal, but the shape of recommended ranges is not limited to cuboidal shapes and may be any shapes including any polyhedral shapes, spherical shapes, and the like. Also, each recommended range does not necessarily have to be designated as a closed space surrounded by a finite shape, and may be designated as a space with a part thereof open.

The recommended range holding unit 126 receives the information of the recommended range for each virtual advertisement group transmitted from the recommended range determination unit 125, and stores and holds it in the storage device, such as an HDD or a RAM.

The UI generation unit 127 generates UIs to be presented to the operator. The UIs generated by the UI generation unit 127 are displayed on the display 140, and the operator can perform operations on the UIs displayed on the display 140 with a mouse, a keyboard, and/or the like while checking them. Examples of the UIs generated by the UI generation unit 127 include the UI 601 illustrated in FIG. 6 and the UI 701 illustrated in FIG. 7, which will be described later, and so on. The UI generation unit 127 obtains the information of the recommended range for each virtual advertisement group held by the recommended range holding unit 126. The UI generation unit 127 also receives the virtual camera parameters transmitted from the parameter calculation unit 121. The UI generation unit 127 generates a UI for recommending virtual advertisement groups based on the recommended range for each virtual advertisement group and the virtual camera parameters.

Specifically, in a case where the virtual camera position for generating a virtual viewpoint image of the current processing target is within the recommended range for a virtual advertisement group, the UI generation unit 127 generates a UI recommending this virtual advertisement group. In the UI 701 exemplarily illustrated in FIG. 7, whether the virtual advertisement groups are recommended is expressed based on whether respective panels 714 to 719 are lit. For example, in a case where one of the panels 714 to 719 in the UI 701 illustrated in FIG. 7 is lit, it indicates that the virtual advertisement group corresponding to the panel is recommended. Specifically, for example, the UI 701 illustrated in FIG. 7 represents a state where the virtual advertisement groups with the virtual advertisement group IDs 1, 2, and 5 are recommended.

The virtual camera information transmission unit 128 obtains the virtual advertisement group IDs held by the group ID holding unit 124. Moreover, the virtual camera information transmission unit 128 receives the virtual camera parameters transmitted from the parameter calculation unit 121 and the timecode transmitted from the timecode calculation unit 122. Furthermore, the virtual camera information transmission unit 128 generates virtual camera information containing the obtained virtual advertisement group IDs and the received virtual camera parameters and timecode, and transmits the generated virtual camera information to the image generation apparatus 104.

A virtual advertisement generation apparatus 106 generates data of a virtual advertisement(s) created by the user with versatile application software capable of creating data of virtual objects, which are three-dimensional objects, as data of a virtual object(s). The data of the at least one virtual object as a virtual advertisement generated by the virtual advertisement generation apparatus 106 is transmitted to the image generation apparatus 104.

The image generation apparatus 104 generates a virtual viewpoint image and outputs a signal representing the generated virtual viewpoint image to a display 105 to display the virtual viewpoint image on the display 105. The image generation apparatus 104 has an image generation unit 110, a group registration unit 111, and a group holding unit 112.

The image generation unit 110 obtains three-dimensional shape data representing the three-dimensional shapes of a foreground and a background from the shape data storage apparatus 103. The image generation unit 110 also receives the virtual camera information transmitted from the virtual camera information transmission unit 128. The image generation unit 110 generates a virtual viewpoint image based on the obtained three-dimensional shape data and the received virtual camera information and outputs a signal representing the generated virtual viewpoint image to the display 105. Note that the virtual camera information includes the virtual camera parameters including information such as the position, orientation, and angle of view of the virtual camera, a timecode, and a virtual advertisement group ID.

The process of generating the virtual viewpoint image includes the following processes. The first one is a process of obtaining the three-dimensional shape data of the foreground and the background corresponding to the timecode included in the virtual camera information from the shape data storage apparatus 103. The second one is a process of obtaining data of the virtual advertisement group corresponding to the virtual advertisement group ID included in the virtual camera information from the group holding unit 112. The third one is a process of generating a virtual viewpoint image based on the obtained three-dimensional shape data of the foreground and the background, the data of the virtual advertisement group obtained from the group holding unit 112, and the virtual camera parameters included in the virtual camera information. Specifically, this process generates an image of the three-dimensional shapes of the foreground and the background represented by the three-dimensional shape data and the virtual advertisements as the virtual objects included in the virtual advertisement group as viewed from the virtual viewpoint determined based on the virtual camera parameters as a virtual viewpoint image. Incidentally, the output destination of the virtual viewpoint image is not necessarily limited to the display 105, and the data of the virtual viewpoint image may be output to, for example, an image distributor, a broadcast station, or the like.

The group registration unit 111 receives the data of the virtual advertisement as a virtual object transmitted from the virtual advertisement generation apparatus 106 and registers the received data of the virtual advertisement in a virtual advertisement group. Specifically, the group registration unit 111 associates the received data of the virtual advertisement with a virtual advertisement group ID and transmits them to the group holding unit 112. The group holding unit 112 receives the data of the virtual advertisement and the virtual advertisement group ID from the group registration unit 111. The group holding unit 112 associates the received data of the virtual object with the received virtual advertisement group ID and stores and holds them in a storage device, such as an HDD or a RAM. Note that, in the present embodiment, the data of the virtual advertisement as a virtual object includes the position of the virtual object in the virtual space, the shape of the virtual object, and information of the content represented by the virtual object but is not limited to those. For example, the configuration may be such that the data of the virtual object includes information of only the position and shape mentioned above, and the information of the content mentioned above can be designated separately. Here, in a case where the virtual object is a virtual advertisement, for example, the information of the content refers to information of an image or the like representing the content of the advertisement.

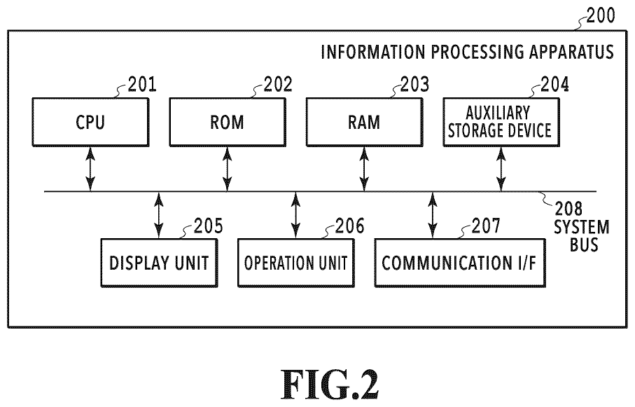

FIG. 2 is a block diagram illustrating an example of the hardware configuration of apparatuses included in the control system according to Embodiment 1. The shape data generation apparatus 102, the shape data storage apparatus 103, the image generation apparatus 104, the virtual advertisement generation apparatus 106, and the virtual camera control apparatus 120 can be implemented with an information processing apparatus 200 illustrated in FIG. 2. The information processing apparatus 200 can have a CPU 201, a read-only memory (ROM) 202, a RAM 203, an auxiliary storage device 204, a display unit 205, an operation unit 206, a communication I/F 207, and a system bus 208.

The CPU 201 comprehensively controls the information processing apparatus 200 by using computer programs and data stored in the ROM 202, the RAM 203, or the like to implement the function of each apparatus included in the system illustrated in FIG. 1. Note that the information processing apparatus 200 may have one or more dedicated pieces of hardware other than the CPU 201, and at least part of processing by the CPU 201 may be executed by the dedicated pieces of hardware. Examples of such dedicated pieces of hardware include an application-specific integrated circuit (ASIC), a field-programmable gate array (FPGA), a digital signal processor (DSP), and so on. The ROM 202 stores programs requiring no change and the like. The RAM 203 temporarily stores programs and data supplied from the auxiliary storage device 204, data externally supplied via the communication I/F 207, and the like. The auxiliary storage device 204 is a hard disk drive or the like and stores various pieces of data such as pieces of image data or acoustic data.

The display unit 205 includes a liquid crystal display, a light emitting diode (LED) display, or the like and displays graphical user interfaces (GUIs) for the user to give instructions to the information processing apparatus 200. The operation unit 206 includes a keyboard, a mouse, a joystick, a touch panel, or the like and inputs various instructions into the CPU 201 in response to receiving operations from the user. The CPU 201 operates as a display control unit that controls the display unit 205 and as an operation control unit that controls the operation unit 206.

The communication I/F 207 is used for communication of the information processing apparatus 200 with external apparatuses, such as the image capturing apparatus group 101, the displays 105 and 140, the controller 141, other information processing apparatuses 200, and so on. In a case where the information processing apparatus 200 is wired-connected to an external apparatus, a communication cable is connected to the communication I/F 207. In a case where the information processing apparatus 200 has a function of wirelessly communicating with external apparatuses, the communication I/F 207 includes an antenna. The system bus 208 connects the components of the information processing apparatus 200 and transfers information to and from them. Incidentally, in the present embodiment, the display unit 205 and the operation unit 206 are present in the information processing apparatus 200, but at least one of the display unit 205 or the operation unit 206 may be present as a separate device outside the information processing apparatus 200.

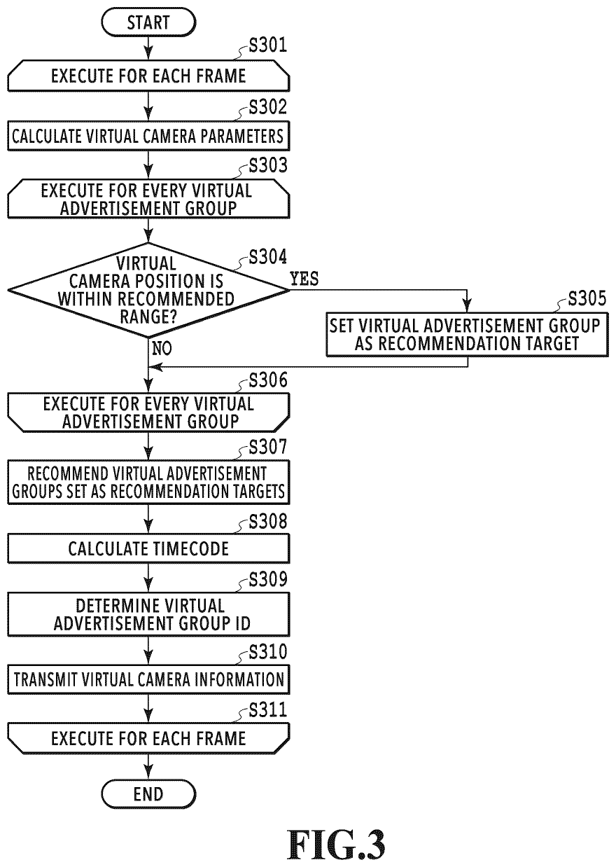

Operation of the virtual camera control apparatus 120 will now be described with reference to FIGS. 3 to 5. FIG. 3 is a flowchart illustrating an example of a processing flow of a process of recommending virtual advertisement groups to the operator by the virtual camera control apparatus 120 according to Embodiment 1. Note that each symbol “S” in the following description means a step. Also, the processes illustrated in this flowchart are implemented by loading program code stored in the ROM 202, the auxiliary storage device 204, or the like to the RAM 203 and causing the CPU 201 to execute the program.

Note that S301 and S311 represent repetition processing. The virtual camera control apparatus 120 repetitively executes the processes of S302 to S310 for each frame in a virtual viewpoint image generated by the image generation apparatus 104. In the present embodiment, the frame rate of the virtual viewpoint image is set to 59.94 fps (frames per second). That is, in playback of a virtual viewpoint image, the series of processes of S302 to S310 are performed at intervals of 1/59.94 second. The intervals for the series of processes from S302 to S310 are dependent on the frame rate of the virtual viewpoint image.

First, in S302, the parameter calculation unit 121 calculates the virtual camera parameters, which include information of the position, orientation, and angle of view of the virtual camera, based on operation information from the controller 141 operated by the operator. For example, in a case where the operator operates the controller, which includes a joystick, to operate the virtual camera, the parameter calculation unit 121 calculates the three-dimensional position of the virtual camera based on the amount of tilt of the joystick and its orientation. Note that S303 and S306 represent repetition processing. The virtual camera control apparatus 120 repetitively executes the processes of S304 and S305 for each virtual advertisement group. That is, the processes of S304 and S305 are repetitively executed after S302.

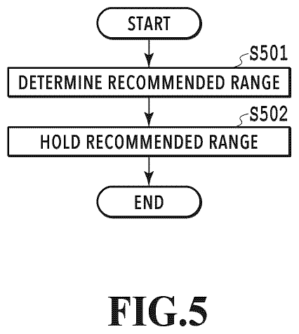

First, in S304, the UI generation unit 127 judges whether the virtual camera position determined based on the virtual camera parameters calculated in S302 is present within the recommended range for the virtual advertisement group. Note that the recommended range for each virtual advertisement group are determined in advance before the start of the processing of the flowchart illustrated in FIG. 3 by the determination method to be described later using FIG. 5, for example. Also, the UI generation unit 127 obtains information of the recommended range for each virtual advertisement group in advance with any timing such as before the start of the processing of the flowchart illustrated in FIG. 3.

A specific example of the judgment method will be described based on a case where the virtual camera position is expressed with three-dimensional coordinates [X, Y, Z], and their values are X=4.0, Y=9.0, and Z=1.5. In the case of the UI 601 illustrated in FIG. 6 to be described later, 3.0 to 5.0 in the X-axis direction, 0.0 to 15.0 in the Y-axis direction, and 0.0 to 20.0 in the Z-axis direction are designated in the text box group 602 as the recommended range for the virtual advertisement group with the virtual advertisement group ID 1. The virtual camera position in the X-axis direction, which is 4.0, falls within the range X of 3.0 to 5.0 designated in the text box group 602. Likewise, the virtual camera position in the Y-axis direction, which is 9.0, falls within the range Y of 0.0 to 15.0, and the virtual camera position in the Z-axis direction, which is 1.5, falls within the range Z of 0.0 to 20.0.

This means that all the virtual camera positions in the X-, Y-, and Z-axis directions fall within the recommended range. The UI generation unit 127 therefore judges that the virtual camera is present within the recommended range for the virtual advertisement group with the virtual advertisement group ID 1. Thus, the UI generation unit 127 judges that the virtual camera position is present within the recommended range in a case where the X, Y, and Z coordinates of the virtual camera position fall within all of the ranges X, Y, and Z, respectively. On the other hand, in a case where the virtual camera position does not fall within one or more of the ranges X, Y, and Z, the UI generation unit 127 judges that the virtual camera position is not present within the recommended range. In S304, the UI generation unit 127 similarly makes a judgment for every virtual advertisement group for which a recommended range has been designated through the repetition processing mentioned above.

Note that the upper limit value of a range does not necessarily have to be designated, like the range X in the text box group 603. In this case, the UI generation unit 127 assumes that the virtual camera position in the X-axis direction is present within the recommended range in the X-axis direction as long as the virtual camera position in the X-axis direction is −15.0 or more as indicated by the range X in the text box group 603. This applies similarly to the ranges Y and Z as well. Likewise, the lower limit value of at least one of the ranges X, Y, and Z does not necessarily have to be designated. In this case, the virtual camera position in the axis direction without a designated lower limit value for the range is considered to be present within the recommended range in this axis direction as long as the virtual camera position in the axis direction is the upper limit value or less.

Also, neither of the lower and upper limit values of a range necessarily has to be designated, like the range Z in the text box group 604. For example, in a case where neither of the upper and lower limit values of the range Z is designated, the UI generation unit 127 only judges whether the virtual camera positions in the X-and Y-axis directions are present in the recommended range. The UI generation unit 127 then judges that the virtual camera position is within the recommended range in a case where the X coordinate of the virtual camera position is within the range X and the Y coordinate of the virtual camera position is within the range Y. For the ranges X and Y too, judgments are made similarly in a case where neither of the lower and upper limit values is designated. Also, like the text box group 605, upper and lower limit values do not necessarily have to be designated for any of the ranges X, Y, and Z. In this case, the UI generation unit 127 judges that the virtual camera position is present within the recommended range regardless of the virtual camera position.

If judging in S304 that the virtual camera position is present within the recommended range, then in S305, the UI generation unit 127 sets the virtual advertisement group as a recommendation target. After S305 or if judging in S304 that the virtual camera position is not present within the recommended range, the UI generation unit 127 judges whether the process of S304 has been executed for all of the virtual advertisement groups for which a recommended range has been designated. If judging that the process of S304 has not been executed for at least one of the virtual advertisement groups, the UI generation unit 127 executes the process of S304 for the virtual advertisement group for which the process of S304 has not yet been executed through the repetition processing mentioned above. If it is judged that the process of S304 has been executed for all of the virtual advertisement groups, the virtual camera control apparatus 120 terminates the repetition processing, and the UI generation unit 127 executes the process of S307.

In S307, the UI generation unit 127 generates a UI for recommending all of the virtual advertisement groups set as recommendation targets in S305. For example, on the UI 701 illustrated in FIG. 7, which will be described later, the operator can visually recognize the recommended virtual advertisement groups based on whether the corresponding ones of the panels 714 to 719 are lit. Specifically, for example, the example of the UI 701 illustrated in FIG. 7 represents a state where the virtual advertisement groups with the virtual advertisement group IDs 1, 2, and 5 are recommended.

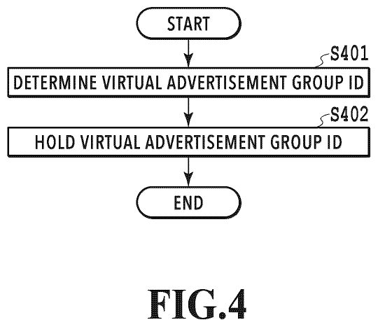

Next, in S308, the timecode calculation unit 122 calculates a timecode for the virtual viewpoint image based on operation information from the controller 141 operated by the operator. For example, the operator operates the jog dial of the controller 141 to input an instruction to play, pause, rewind, or fast-forward the virtual viewpoint image or another similar action. The timecode calculation unit 122 receives operation information corresponding to this input transmitted from the controller 141 and calculates a timecode based on this operation information. Next, in S309, the virtual camera control apparatus 120 performs a process of determining a virtual advertisement group ID based on the operator's designation. Details of this determination process will be described later by using FIG. 4.

Next, in S310, the virtual camera information transmission unit 128 transmits virtual camera information to the image generation apparatus 104. Specifically, in the process of S310, the virtual camera information transmission unit 128 obtains the virtual advertisement group ID determined in S309. Moreover, in the process of S310, the virtual camera information transmission unit 128 obtains the virtual camera parameters calculated by the parameter calculation unit 121 in S302 and the timecode calculated by the timecode calculation unit 122 in S308. Furthermore, in the process of S310, the virtual camera information transmission unit 128 generates virtual camera information including the obtained virtual advertisement group ID, virtual camera parameters, and timecode, and transmits this to the image generation unit 110.

As described above, the virtual camera control apparatus 120 repetitively executes the processes of S302 to S310, for example, until the operator inputs an instruction to terminate the processing by the virtual camera control apparatus 120. In this case, the virtual camera control apparatus 120 terminates the processing of the flowchart illustrated in FIG. 3 in response to the input from the operator.

FIG. 4 is a flowchart illustrating an example of the flow of the process of determining a virtual advertisement group ID based on the operator's designation by the virtual camera control apparatus 120 according to Embodiment 1. Specifically, this flowchart illustrates an example of the flow of the process in S309, and the processing of this flowchart is executed after S308. Note that the processes illustrated in this flowchart are implemented by loading program code stored in the ROM 202, the auxiliary storage device 204, or the like to the RAM 203 and causing the CPU 201 to execute the program.

First, in S401, the group ID determination unit 123 determines a virtual advertisement group ID based on the operator's designation. For example, using a mouse, the operator selects and presses one of the buttons 708 to 713 in the UI 701 exemplarily illustrated in FIG. 7, which will be described later, to designate a desired virtual advertisement group ID. The example of the UI 701 illustrated in FIG. 7 represents a state where the operator has selected and pressed the button 709. In this state, the group ID determination unit 123 determines 2 as the virtual advertisement group ID.

Next, in S402, the group ID holding unit 124 receives the virtual advertisement group ID determined in S401 and holds this virtual advertisement group ID. In the example of the UI 701 illustrated in FIG. 7, the group ID holding unit 124 holds 2 as the virtual advertisement group ID. Note that, in the process of S310 to obtain the virtual advertisement group ID determined in S309, the virtual camera information transmission unit 128 obtains the virtual advertisement group ID held by the group ID holding unit 124 in S402. After S402, the virtual camera control apparatus 120 terminates the processing of the flowchart illustrated in FIG. 4, and then executes the process of S310.

FIG. 5 is a flowchart illustrating an example of the flow of the process of determining the recommended range for each virtual advertisement group based on the operator's designation by the virtual camera control apparatus 120 according to Embodiment 1. Note that the processing of this flowchart is executed, for example, before the execution of the processing of the flowchart illustrated in FIG. 3. Also, the processes illustrated in the flowchart illustrated in FIG. 5 are implemented by loading program code stored in the ROM 202, the auxiliary storage device 204, or the like to the RAM 203 and causing the CPU 201 to execute the program.

First, in S501, the recommended range determination unit 125 determines recommended ranges for virtual advertisement groups based on the operator's designation. For example, using a mouse and a keyboard, the operator inputs desired numerical values into any of the text box groups 602 to 606 in the UI 601 exemplarily illustrated in FIG. 6, which will be described later, to designate recommended ranges for desired virtual advertisement groups. The example of the text box group 602 in the UI 601 illustrated in FIG. 6 represents a state where 1 is designated as the virtual advertisement group ID. The example also represents a state where 3.0 to 5.0 in the X-axis direction, 0.0 to 15.0 in the Y-axis direction, and 0.0 to 20.0 in the Z-axis direction are designated as a recommended range for the virtual advertisement group with the virtual advertisement group ID 1. Based on this designation, the recommended range determination unit 125 determines a recommended range for the virtual advertisement group with the virtual advertisement group ID 1.

Next, in S502, the recommended range holding unit 126 receives information of the recommended range for each virtual advertisement group determined in S501, and holds this information. After S502, the virtual camera control apparatus 120 terminates the processing of the flowchart illustrated in FIG. 5. Note that the information of the recommended range for each virtual advertisement group held in S502 will be obtained by the UI generation unit 127 with any timing such as before the start of the processing of the flowchart illustrated in FIG. 3.

FIG. 6 is a diagram illustrating an example of the UI 601 generated by the UI generation unit 127 according to Embodiment 1 for the operator to designate a recommended range for each virtual advertisement group. Note that the display form of the UI 601 is not limited in the present disclosure. For example, the UI 601 may be displayed as a single window or displayed as a part of a single UI including the UI 601 and another UI for controlling the virtual camera.

The text box groups 602 to 606 are regions for the operator to designate recommended ranges for respective virtual advertisement groups by using devices for inputting operations, such as a mouse and a keyboard. On the UI 601, a recommended range for the virtual advertisement group with the virtual advertisement group ID 1 is designated in the text box group 602. Likewise, recommended ranges for the virtual advertisement groups with the virtual advertisement group IDs 2, 3, and 5 are designated in the text box groups 603, 604, and 605, respectively. The text box group 606 is in a state where no virtual advertisement group ID is input and no recommended range is designated for any virtual advertisement group.

In one example, the operator inputs and designates virtual advertisement group IDs and recommended ranges for the virtual advertisement groups corresponding to the desired virtual advertisement group IDs and then presses a confirm button or the like not illustrated in FIG. 6. In response to the pressing of the confirm button or the like as a trigger, the recommended range determination unit 125 determines the recommended range for each virtual advertisement group based on the information set in the text box groups 602 to 606 in the UI 601 illustrated in FIG. 6.

FIG. 7 is a diagram illustrating an example of the UI 701 generated by the UI generation unit 127 according to Embodiment 1 for the operator to designate a virtual advertisement group to be placed in the virtual space. Note that the display form of the UI 701 is not limited in the present disclosure. For example, the UI 701 may be displayed as a single window or displayed as a part of a UI including the UI 701 and another UI for controlling the virtual camera.

Images 702 to 707 each indicate a layout of one or more virtual advertisements as virtual objects belonging to a virtual advertisement group in a case where the virtual objects are placed in the virtual space. Referring to the images 702 to 707, the operator selects a virtual advertisement group. The virtual advertisement group IDs of the virtual advertisement groups corresponding to the images 702 to 707 are displayed above the images 702 to 707, respectively. Each of the images 702 to 707 may be, for example, automatically generated based on information of the position of the one or more virtual advertisements (virtual objects) belonging to the corresponding virtual advertisement group in the virtual space. Alternatively, each of the images 702 to 707 may be an image created separately and manually by the creator of the virtual advertisement(s) or the like. Incidentally, in the images 702 to 707 illustrated in the UI 701 in FIG. 7, only the shapes and layouts of the virtual advertisements are illustrated as simplified information, but the virtual advertisements in the images 702 to 707 may include their contents. In this case, the images 702 to 707, which are automatically generated, are generated, for example, based on information of the positions of the virtual advertisements belonging to the corresponding virtual advertisement groups in the virtual space and information of the contents of the virtual advertisements.

The buttons 708 to 713 are intended for the operator to designate the virtual advertisement group ID of a virtual advertisement group which the operator wishes to display in a virtual viewpoint image. In one example, the buttons 708 to 713 are each selectable with a click operation on a mouse. With this operation, the operator selects the button corresponding to a virtual advertisement group which the operator wishes to display in the virtual viewpoint image from among the buttons 708 to 713. In response to the designation through the operation, the group ID determination unit 123 determines the virtual advertisement group ID corresponding to the selected button.

Note that the method for the operator to designate a virtual advertisement group ID in the present disclosure is not limited to this method. For example, the operator may designate a virtual advertisement group ID by selecting one of the images 702 to 707 or designate a virtual advertisement group ID by directly inputting the value of the virtual advertisement group ID by using a keyboard. The example of the UI 701 illustrated in FIG. 7 represents a state where the button 709 is selected, i.e., a state where the virtual advertisement group with the virtual advertisement group ID 2 is selected. In this state, the one or more virtual advertisements included in the virtual advertisement group with the virtual advertisement group ID 2 can be displayed in the virtual viewpoint image.

The panels 714 to 719 each indicate whether the corresponding virtual advertisement group is a recommendation target. For example, of the multiple virtual advertisement groups corresponding to the panels 714 to 719, the virtual advertisement groups corresponding to the panels that are lit represent virtual advertisement groups set as recommendation targets, i.e., recommended virtual advertisement groups. The virtual advertisement groups corresponding to the panels that are not lit represent virtual advertisement groups not set as recommendation targets, i.e., unrecommended virtual advertisement groups. In the example of the UI 701 illustrated in FIG. 7, the panels 714, 715, and 718 are lit, and the panels 716, 717, and 719 are not lit. That is, the example of the UI 701 represents a state where the virtual advertisement groups corresponding to the virtual advertisement group IDs 1, 2, and 5 are recommended.

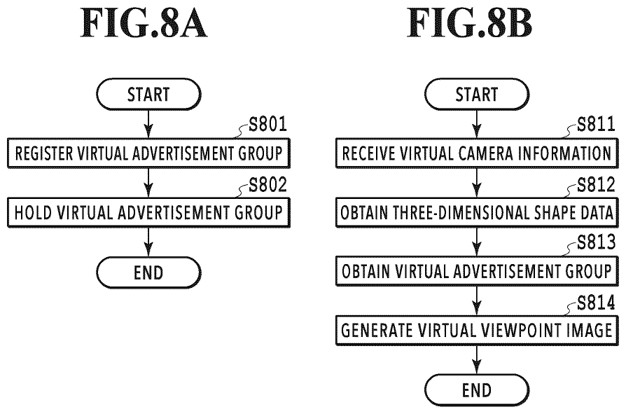

Operation of the image generation apparatus 104 will be described with reference to FIG. 8. FIG. 8A is a flowchart illustrating an example of the flow of the process of registering virtual advertisement groups by the image generation apparatus 104 according to Embodiment 1. FIG. 8B is a flowchart illustrating an example of the flow of the process of generating a virtual viewpoint image by the image generation apparatus 104 according to Embodiment 1.

The flow of the process of registering virtual advertisement groups by the image generation apparatus 104 will be described with reference to FIG. 8A. First, in S801, the group registration unit 111 receives data of one or more virtual objects as virtual advertisements transmitted from the virtual advertisement generation apparatus 106 and registers the received data of the one or more virtual objects as data of a virtual advertisement group. Specifically, the group registration unit 111 registers the data of the one or more virtual objects as virtual advertisements and a virtual advertisement group ID designated by the user of the virtual advertisement generation apparatus 106 in association with each other. Next, in S802, the group holding unit 112 receives the data of the virtual objects registered in S801, which is associated with the virtual advertisement group ID, and holds this as a virtual advertisement group. After S802, the image generation apparatus 104 terminates the processing of the flowchart illustrated in FIG. 8A. Note that the processing of the flowchart is executed in advance with any timing before the start of the processing of the flowchart illustrated in FIG. 8B.

The flow of the process of generating a virtual viewpoint image by the image generation apparatus 104 will now be described with reference to FIG. 8B. The processing of the flowchart illustrated in FIG. 8 is repetitively executed for each frame in the virtual viewpoint image, for example. First, in S811, the image generation unit 110 receives the virtual camera information transmitted from the virtual camera control apparatus 120, specifically, the virtual camera information transmission unit 128. Next, in S812, the image generation unit 110 obtains the three-dimensional shape data of the foreground and the background corresponding to the timecode included in the virtual camera information received in S811 by reading it out of the shape data storage apparatus 103. Next, in S813, the image generation unit 110 obtains data of the virtual advertisement group corresponding to the virtual advertisement group ID included in the virtual camera information received in S811 from the group holding unit 112.

Next, in S814, the image generation unit 110 generates a virtual viewpoint image. Specifically, the image generation unit 110 generates a virtual viewpoint image based on the virtual camera parameters included in the virtual camera information received in S811, the three-dimensional shape data of the foreground and the background obtained in S812, and the data of the virtual advertisement group obtained in S813. Note that the virtual viewpoint image generated in S814 is a frame in the virtual viewpoint image corresponding to the timecode included in the virtual camera information received in S811. Also, the virtual viewpoint image generated in S814 is displayed on the display 105. After S814, the image generation apparatus 104 terminates the processing of the flowchart illustrating in FIG. 8B and will repetitively execute the processing of this flowchart each time new virtual camera information is transmitted from the virtual camera control apparatus 120.

As described above, a recommended range is designated for each virtual advertisement group, and the virtual camera control apparatus 120 is configured to recommend a virtual advertisement group to the operator in a case where the virtual camera position is present within the recommended range for this virtual advertisement group. Such a virtual camera control apparatus 120 enables the operator to easily and instantaneously determine which virtual advertisement group to select that is to be displayed in the virtual viewpoint image. The virtual camera control apparatus 120 therefore improves the likelihood of displaying a virtual advertisement(s) suitable for the virtual camera position in the virtual viewpoint image.

Note that, in the present embodiment, a configuration in which only a single virtual advertisement group is selected has been described as an example, but multiple virtual advertisement groups may be selected. In this case, all of the virtual advertisements included in the selected multiple virtual advertisement groups are placed in the virtual space, for example.

Also, in the present embodiment, a configuration in which a range for the virtual camera position is designated as a recommended range has been described an example, but the designation of the recommended range is not limited to the virtual camera position. For example, the values of Pan, Tilt, and Roll indicating the orientation of the virtual camera or the value of Zoom indicating the angle of view of the virtual camera may be designated the recommended range, or a combination of at least two of the position, orientation, and angle of view of the virtual camera may be designated as the recommended range. Even in such a case, the method of judging whether any of the above parameters is within a recommended range, that is, whether to set the corresponding virtual advertisement group as a recommendation target, is similar to the method described in the present embodiment. For example, to make the value of Pan registrable as a recommended range, a text box for designating a range for Pan may be added to the UI 601 illustrated in FIG. 6. Also, in the judgment in S304 illustrated in FIG. 3, whether the value of Pan of the virtual camera is included in a range for Pan designated by the operator may be additionally judged. This applies similarly to Tilt, Roll, and Zoom as well.

Also, in the present embodiment, a configuration in which virtual advertisements are recommended based on the current virtual camera position has been described as an example. Alternatively, a configuration in which virtual advertisements are recommended in association with respective camera paths created in advance may be employed. Here, a “camera path” is a record of all changes in the virtual camera parameters over time, and holds the virtual camera parameters at all times in a given period. For example, the configuration is such that, in a case where the ratio of presence of the virtual camera position across all times along a camera path as mentioned above in the recommended range for a virtual advertisement group is a preset threshold value or more, this virtual advertisement group is set as a recommendation target for the camera path. Alternatively, the configuration may be such that, for example, the virtual advertisement group corresponding to the recommended range in which the ratio of presence of the virtual camera position across all of the times along the camera path is highest may be set as a recommendation target.

### Embodiment 2

In Embodiment 1, a configuration that recommends virtual advertisement groups based on the position of the virtual camera and the like has been described. Here, the virtual advertisement groups set as recommendation targets may be frequently switched, for example, in a case where the position, orientation, or angle of view of the virtual camera intensely changes, such as in a case where the virtual camera is operated to follow an object moving inside the virtual space. In such a case, the panels 714 to 719 in the UI 701 illustrated in FIG. 7 will become lit and unlit back and forth at short time intervals. This may render the UI such that virtual advertisement groups set as recommendation targets are difficult to visually recognize for the operator. In view of this, in Embodiment 2, a description will be given of an example of a preferable method of recommending virtual advertisement groups, for example, in a case where the moving speed of the virtual camera exceeds a preset threshold value.

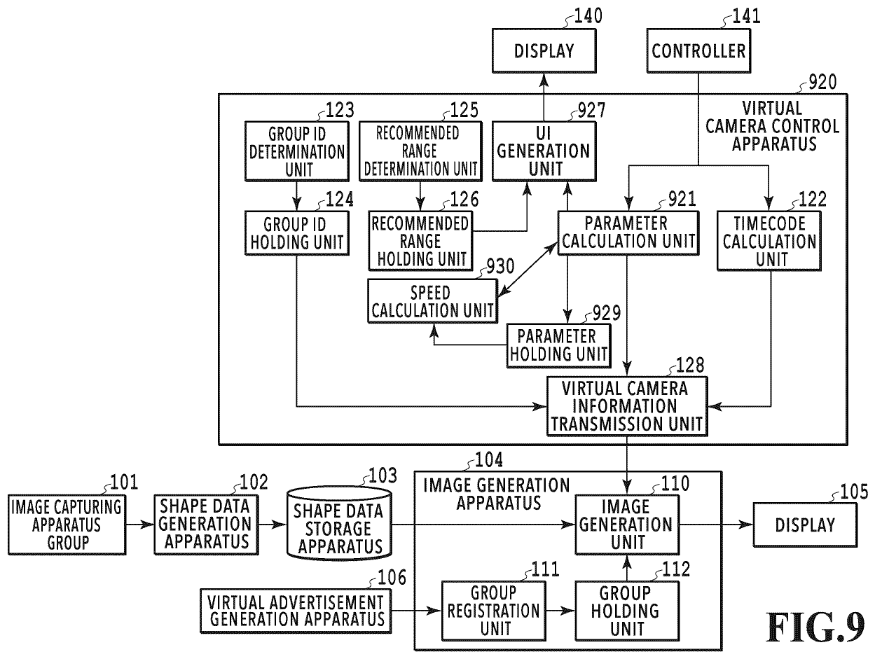

FIG. 9 is a block diagram illustrating an example of the configuration of a control system according to Embodiment 2. Incidentally, in the present embodiment, only the features different from FIG. 1 will be described. In FIG. 9, the components denoted by the same reference signs as those in FIG. 1 are the same as the components illustrated in FIG. 1. A virtual camera control apparatus 920 has a parameter calculation unit 921, a parameter holding unit 929, and a speed calculation unit 930 in addition to the functional components included in the virtual camera control apparatus 120 illustrated in FIG. 1. Moreover, in the virtual camera control apparatus 920, the UI generation unit 127 illustrated in FIG. 1 is changed to a UI generation unit 927. As in Embodiment 1, processing by the parameter calculation unit 921, the parameter holding unit 929, the speed calculation unit 930, and the UI generation unit 927 is implemented by causing the CPU 201 to execute programs loaded to the RAM 203.

The parameter calculation unit 921 has the following function in addition to the function of the parameter calculation unit 121 according to Embodiment 1. Specifically, the parameter calculation unit 921 transmits calculated virtual camera parameters to the parameter holding unit 929. The parameter calculation unit 921 also transmits the calculated virtual camera parameters to the speed calculation unit 930, and receives the moving speed of the virtual camera as a return value for the parameters. Moreover, the parameter calculation unit 921 adds information of the received moving speed of the virtual camera to the virtual camera parameters transmitted to the speed calculation unit 930, and transmits the virtual camera parameters after the addition to the UI generation unit 927.

The parameter holding unit 929 receives the virtual camera parameters transmitted from the parameter calculation unit 921 and holds the received virtual camera parameters. Specifically, the parameter holding unit 929 overwrite the virtual camera parameters which it previously received and held with the newly received virtual camera parameters and holds the latest virtual camera parameters.

The speed calculation unit 930 receives the virtual camera parameters corresponding to the latest frame (hereinafter referred to as “current frame”) transmitted from the parameter calculation unit 921. Moreover, the speed calculation unit 930 obtains the virtual camera parameters corresponding to the immediately preceding frame (hereinafter referred to as “preceding frame”) held by the parameter holding unit 929. Furthermore, the speed calculation unit 930 calculates the moving speed of the virtual camera based on the virtual camera parameters in the preceding frame and the virtual camera parameters in the current frame. The speed calculation unit 930 transmits information of the calculated moving speed of the virtual camera to the parameter calculation unit 921 as a return value for the virtual camera parameters received from the parameter calculation unit 921.

The moving speed of the virtual camera can be calculated by dividing the distance between the virtual camera position in the preceding frame and the virtual camera position in the current frame by the time period between the preceding frame and the current frame (hereinafter referred to as “frame interval”). For example, in a case where the frame rate is 59.94 fps, the frame interval is 1/59.94 second. With F as the frame rate, (X, Y, Z) as the three-dimensional coordinates of the virtual camera position in the current frame, and (Xₚ, Yₚ, Zₚ) as the three-dimensional coordinates of the virtual camera position in the preceding frame, the moving speed of the virtual camera, denoted as V, can be calculated by the Formula (1) below.

$$V = {\{ {( X - {X}_{p} )}^{2} + {( Y - {Y}_{p} )}^{2} + {( Z - {Z}_{p} )}^{2} \}}^{1 / 2} / ( 1 / F ) \qquad Formula ( 1 )$$

The UI generation unit 927 has the following function in addition to the function of the UI generation unit 127 according to Embodiment 1. Specifically, the UI generation unit 927 does not recommend virtual advertisement groups in a case where the moving speed of the virtual camera included in the received virtual camera parameters is a preset threshold value or more. Specifically, the UI generation unit 927 maintains the UI generated for the preceding frame or before it. Incidentally, the threshold value may be a value set in advance by the system or a value set as appropriate by the operator or another user.

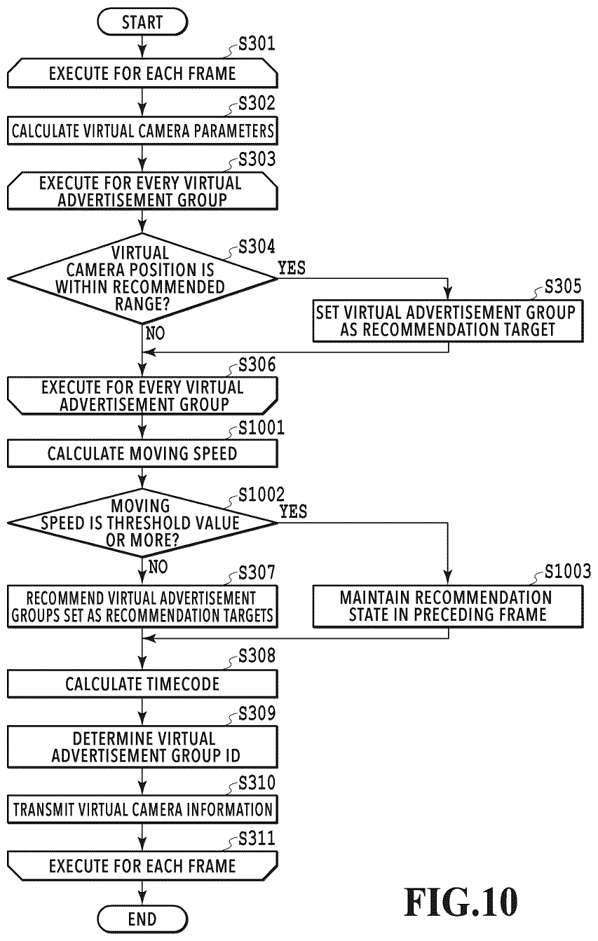

FIG. 10 is a flowchart illustrating an example of a processing flow of a process of recommending virtual advertisement groups to the operator by the virtual camera control apparatus 920 according to Embodiment 2. Note that the processes illustrated in this flowchart are implemented by loading program code stored in the ROM 202, the auxiliary storage device 204, or the like to the RAM 203 and causing the CPU 201 to execute the program.

In the flowchart illustrated in FIGS. 10, S301 to S311 are processes similar to S301 to S311 in the flowchart illustrated in FIG. 3, and description thereof is therefore omitted. If it is judged that the process of S304 has been executed for all of the virtual advertisement groups in the repetition processing from S302 to S306, the virtual camera control apparatus 920 terminates this repetition processing, and the UI generation unit 927 executes the process of S1001.

In S1001, the speed calculation unit 930 calculates the moving speed of the virtual camera based on the virtual camera parameters in the preceding frame and the virtual camera parameters in the current frame. Information of the calculated moving speed of the virtual camera is transmitted to the parameter calculation unit 921. Also, the parameter calculation unit 921 transmits the virtual camera parameters including this information to the UI generation unit 927.

Next, in S1002, the UI generation unit 927 judges whether the moving speed of the virtual camera calculated in S1001 is the threshold value or more. If judging in S1002 that the moving speed is not the threshold value or more, i.e., less than the threshold value, the UI generation unit 927 executes the process of S307. If judging in S1002 that the moving speed is the threshold value or more, then in S1003, the UI generation unit 927 maintains the recommendation state in the preceding frame. Specifically, the UI generation unit 927 maintains the UI generated for the preceding frame or before it. In the present embodiment, the method of maintaining the recommendation state is not limited. For example, the UI generation unit 927 may generate a UI being the UI 701 exemplarily illustrated in FIG. 7 maintaining the lit or unlit state of each of the panels 714 to 719 for the preceding frame. After S307 or S1003, the virtual camera control apparatus 920 executes the process of S308.

As described above, the virtual camera control apparatus 920 is configured not to change the recommendation state in a case where the moving speed of the virtual camera is the threshold value or more. Such a virtual camera control apparatus 920 keeps the recommendation state of virtual advertisement groups from being frequently switched in a case where the virtual camera position changes intensely. Thus, the virtual camera control apparatus 920 prevents display of a UI in which virtual advertisement groups set as recommendation targets are difficult to visually recognize for the operator. Note that, in the present embodiment, a case based on whether the moving speed of the virtual camera is the threshold value or more has been described as an example. Alternatively, the configuration may be such that the recommendation state in the preceding frame are maintained in a case where the rate of change in the orientation or angle of view of the virtual camera is a threshold value or more. Still alternatively, the configuration may be such that whether to maintain the recommendation state in the preceding frame is judged based on any combination of the moving speed of the virtual camera and the rate of change in the orientation and the rate of change in the angle of view.

### Other Embodiments

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer- executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

In accordance with the present disclosure, the operator can easily designate a virtual object(s) suitable for the current virtual camera position.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-115928, which was filed on Jul. 14, 2023, and which is hereby incorporated by reference and wherein in its entirety.

What is claimed is:

1. A control apparatus comprising:
one or more hardware processors; and
one or more memories storing one or more programs configured to be executed by the one or more hardware processors, the one or more programs including instructions for:
obtaining a virtual camera parameter including information of at least one of a position, an orientation, or an angle of view of a virtual camera in a virtual space;
based on the virtual camera parameter, generating a user interface that assists a user to make an input for selecting one or more virtual object groups from among a plurality of virtual object groups to each of which one or more virtual objects belong; and
based on the input for selecting the virtual object groups from the user, determining the virtual object groups.

2. The control apparatus according to claim 1, wherein the virtual camera parameter includes at least the information of the position of the virtual camera.

3. The control apparatus according to claim 1, wherein the virtual object groups are each determined by determining identification information uniquely identifying the virtual object group.

4. The control apparatus according to claim 1, wherein the virtual camera parameter is obtained through calculation.

5. The control apparatus according to claim 1, wherein the virtual camera is a virtual viewpoint in the virtual space in a case of generating a virtual viewpoint image based on a plurality of pieces of image data obtained by image capturing by a plurality of image capturing apparatuses.

6. The control apparatus according to claim 1, wherein
the one or more programs further include instructions for obtaining information of a range for the at least one of the position, the orientation, or the angle of view of the virtual camera included in the virtual camera parameter for each of the plurality of virtual object groups, and
the user interface is generated based on the virtual camera parameter and the information of the range.

7. The control apparatus according to claim 6, wherein
the virtual camera parameter includes at least the information of the position of the virtual camera, and
the information of the range includes at least information indicating a range for the position of the virtual camera.

8. The control apparatus according to claim 6, wherein the information of the range is information based on an input from the user.

9. The control apparatus according to claim 1, wherein
the virtual camera parameter includes at least the information of the position of the virtual camera, and
the one or more programs further include instructions for: calculating a moving speed of the virtual camera based on the information of the position of the virtual camera included in the virtual camera parameter, and
the user interface is not changed in a case where the moving speed of the virtual camera is a threshold value or more.

10. The control apparatus according to claim 1, wherein the virtual objects belonging to the plurality of virtual object groups are each an object in the form of a virtual advertisement that is placeable in the virtual space.

11. The control apparatus according to claim 1, wherein the one or more programs further include instructions for:
obtaining information on each of the plurality of virtual object groups including information on the virtual objects belonging to the each of the plurality of virtual object groups; and
generating a virtual viewpoint image based on the obtained information on the plurality of virtual object groups, identification information capable of uniquely identifying the determined virtual object groups, and information of the virtual camera parameter.

12. A method comprising the steps of:
obtaining a virtual camera parameter including information of at least one of a position, an orientation, or an angle of view of a virtual camera in a virtual space;
based on the virtual camera parameter, generating a user interface that assists a user to make an input for selecting one or more virtual object groups from among a plurality of virtual object groups to each of which one or more virtual objects belong; and
based on the input for selecting the virtual object groups from the user, determining the virtual object groups.

13. A non-transitory computer readable storage medium storing a program for causing a computer to perform a control method of a control apparatus, the control method comprising the steps of:
obtaining a virtual camera parameter including information of at least one of a position, an orientation, or an angle of view of a virtual camera in a virtual space;
based on the virtual camera parameter, generating a user interface that assists a user to make an input for selecting one or more virtual object groups from among a plurality of virtual object groups to each of which one or more virtual objects belong; and
based on the input for selecting the virtual object groups from the user, determining the virtual object groups.
